(19) United States
(12) Patent Application Publication
(10) Pub. No.: US 2020/0309225 A1
(43) Pub. Date: Oct. 1, 2020

(54) BUILT-IN SPATIAL HAMMER TYPE IMPACT DAMPER PLACED IN STEEL TUBE STRUCTURES

(71) Applicant: DALIAN UNIVERSITY OF TECHNOLOGY, Dalian, Liaoning (CN)

(72) Inventors: Shuli FAN, Dalian, Liaoning (CN); Linsheng HUO, Dalian, Liaoning (CN)

(21) Appl. No.: 16/765,578

(22) PCT Filed: Aug. 22, 2018
(86) PCT No.: PCT/CN2018/101653

§ 371 Date: May 20, 2020

(51) Int. Cl. F16F 7/104; F16F 7/00; E04B 1/98

(52) U.S. Cl. CPC F16F 7/104; E04B 1/98; F16F 7/00

(57) ABSTRACT

A built-in spatial hammer type impact damper placed in steel tube structures is provided. A spherical mass oscillator is fixed in the center of an annular sheet housing through springs on the oscillator. Many rigid rods are fixed on the spherical mass oscillator. The annular housing, spherical mass oscillator and springs form a tuned mass damper to offset the vibration of a steel pipe structure caused by external excitation. In addition, viscoelastic energy absorbing caps are settled on the top of the rigid rods and will collide with the sheet housing when host structure vibrating. Multiple springs and rigid rods in an annular plane can reduce the level of vibration in multiple directions. Many dampers are connected through connecting rods to form a spatial hammer type damper which is placed in a circular steel pipe. Vibration reduction efficiency can be increased and the space occupied by dampers can be reduced.

### TECHNICAL FIELD

The present invention belongs to the technical field of vibration control in civil engineering, and relates to a built-in spatial hammer type impact damper placed in steel tube structures.

### BACKGROUND

The technology of using damping to absorb energy and reduce vibration is originally applied in the industries of aerospace, military, guns and automobiles. Since 1970s, the technologies have been gradually transferred to construction, bridge, railway and other projects in many foreign countries, and have been developed rapidly. By the end of the 20th century, dampers were used in more than 100 structural projects in the world to absorb energy and reduce vibration. A damper used to reduce vibration is a passive control system, and reduces the structural response by increasing the structural damping and dissipating vibration energy. The dampers have been widely applied in prospects in practical structural control due to the characteristics of simple device, economical material and good damping effect. There are many types of dampers, which are classified into displacement-related dampers and speed-related dampers. The energy consumption of the displacement-related dampers is relevant to the own deformation and relative sliding displacement. Metal dampers and friction dampers are frequently used as displacement-related dampers. The damping characteristics of the speed-related dampers are relevant to loading frequency. This type damper includes viscous dampers and viscoelastic dampers.

Based on the authors' patent Spatial Damper Combining Multiple Energy Consumption Modes applied in China, the present invention changes the original cuboid housing of the spherical inner cavity to a thin annular housing, limits an elastic rod and a connecting spring to a damper in the plane of the annular housing, uses a threaded elastic connecting rod to connect a plurality of dampers in a direction perpendicular to the plane of the annular housing, finally puts the dampers into a circular steel pipe. The proposed damper absorbs energy and reduces vibration through the spring oscillators and the collision of viscoelastic energy absorbing caps with pipe wall. The present invention not only has various energy consumption modes, but also simply acts on the steel pipe structure, so as to improve vibration reduction and installation efficiency.

### SUMMARY

The purpose of the present invention is to provide a spatial hammer type damper installed in circular steel tube structures. The damper has the advantages of convenient installation and effective vibration-suppressing, does not generate large noise in a vibration reduction process, and overcomes the disadvantages that the original damper should be installed outside on the surface of the host structure.

The technical solution of the present invention is:

A spatial hammer type damper arranged in circular steel tube structures comprises a spherical mass oscillator 1, an annular housing 2, springs 3, rigid rods 4, a viscoelastic energy absorbing cap 5 and a connecting rod 6.

The annular sheet housing 2 surrounds the outer side of a spherical mass oscillator 1. After the annular sheet housing 2 is placed in a circular steel pipe, the annular sheet housing 2 is attached to the inner wall of the steel pipe. In the center surrounded by the annular sheet housing 2, the spherical mass oscillator 1 is connected with the annular sheet housing 2 through the springs 3 thereon. Many rigid rods 4 are fixed to the spherical mass oscillator 1 These rods are perpendicular to a spherical surface and limited in a plane of the annular sheet housing 2 to ensure a certain distance between the viscoelastic energy absorbing cap 5 on the top of the rigid rods 4 and the annular sheet housing 2. The distance is adjusted through the length of the rigid rods 4. The above members form a separate damper. Multiple dampers are connected through the connecting rod 6 with a bolt and are placed in the circular steel pipe to form a spatial hammer type damper. When the circular steel pipe structure vibrates, a vibration component perpendicular to the steel pipe causes the springs 3 to drive the spherical mass oscillator 1 to vibrate. The viscoelastic energy absorbing cap 5 on the top of the rigid rods 4 impacts the annular sheet housing 2, and the viscoelastic material absorbs vibration energy. A vibration component parallel to the steel pipe is consumed by another damper perpendicular to the component in the steel pipe. However, the friction of the annular sheet housing 2 of the damper with the steel pipe can also consume a small part of energy.

The mass of the spherical mass oscillator 1 is determined according to the vibration frequency of the steel pipe structure in the installation position and the spectrum of a load.

The stiffness of the springs 3 is determined according to the vibration frequency of the steel pipe structure in the installation position, the spectrum of the load, and vibration reduction requirements in different directions.

The length of the rigid rods 4 is determined according to the vibration reduction requirements in different directions of the steel pipe structure in the installation position.

The length of the connecting rod 6 is determined according to the attenuation range of the vibration reduction efficiency of a single damper.

When the steel pipe structure attached with the damper vibrates, the spherical mass oscillator 1 connected with the external annular sheet housing 2 through the springs 3 also vibrates, and forms a tuned mass damper with the springs 3 to offset the vibration response of the steel pipe structure caused by part of external excitation. At the same time, the vibration of the spherical mass oscillator 1 causes the collision between the viscoelastic energy absorbing cap 5 on the top of the rigid rods 4 and the annular sheet housing 2. The collision consumes part of vibration energy, and the viscoelastic energy absorbing cap 5 absorbs part of the vibration energy. The spherical mass oscillator 1 is connected with the inner wall of the annular housing of the external annular sheet housing 2 through the springs 3 in multiple directions. The rigid rods 4 are arranged in multiple directions of the spherical mass oscillator 1. Thus, the spherical mass oscillator 1 can vibrate in multiple directions in the plane of the annular housing, and the rigid rods 4 can collide with the annular sheet housing 2.

The present invention has following advantages: the damper of the present invention can be simply installed in the circular steel pipe to save the space and installation cost, and own the characteristic of combining multiple energy consumption modes to achieve good energy consumption and vibration reduction effects. The functions of different vibration reduction effects of steel pipe structures with different sizes and lengths can be realized. By adjusting the stiffness of the springs in multiple directions, the lengths of the rigid rods and the length of the connecting rod.

### DESCRIPTION OF DRAWINGS

FIG. 1 is a structural overall schematic diagram of the present invention.

FIG. 2 is a schematic diagram of structural details of the present invention.

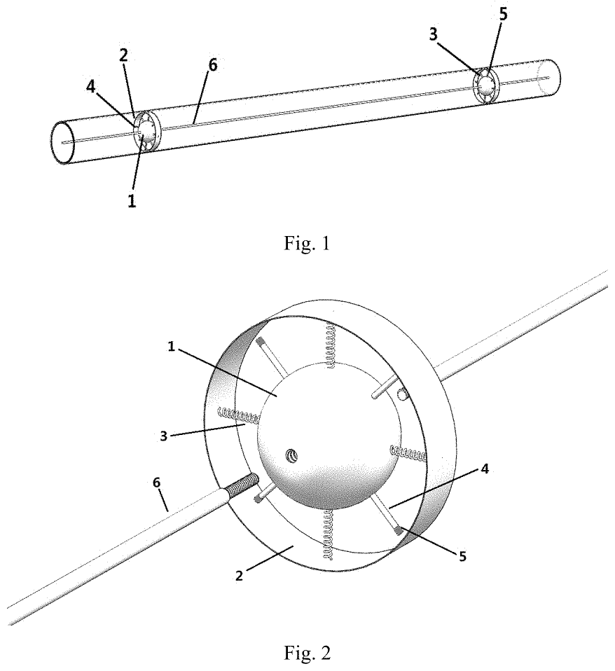

In the figures: 1 spherical mass oscillator; 2 annular housing; 3 spring; 4 rigid rod; 5 viscoelastic energy absorbing cap; and 6 connecting rod.

### DETAILED DESCRIPTION

Specific embodiments of the present invention are further described as follows in combination with accompanying drawings and the technical solution.

A spatial hammer type damper arranged in a circular steel pipe comprises a spherical mass oscillator 1, an annular housing 2, springs 3, rigid rods 4, a viscoelastic energy absorbing cap 5 and a connecting rod 6.

The annular sheet housing 2 surrounds the outer side of the spherical mass oscillator 1. After the annular sheet housing 2 is placed in a circular steel pipe, the annular sheet housing 2 is attached to the inner wall of the steel pipe. In the center surrounded by the annular sheet housing 2, the spherical mass oscillator 1 is connected with the housing through the springs 3. Many rigid rods 4 are fixed to the spherical mass oscillator 1. These rods are perpendicular to a spherical surface and limited in a plane of the annular sheet housing 2 to ensure a certain distance between the viscoelastic energy absorbing cap 5 on the top of the rigid rods and the annular sheet housing 2. The distance is adjusted through the length of the rigid rods 4. The above members form a separate damper. Multiple dampers are connected through the connecting rod 6 with a bolt and are placed in the circular steel pipe to form a spatial hammer type damper. When the circular steel pipe structure vibrates, a vibration component perpendicular to the steel pipe causes the springs 3 to drive the spherical mass oscillator 1 to vibrate. The viscoelastic energy absorbing cap 5 on the top of the rigid rods 4 impacts the annular sheet housing 2, and the viscoelastic material absorbs vibration energy. A vibration component parallel to the steel pipe is consumed by another damper perpendicular to the component in the steel pipe. However, the friction of the annular sheet housing 2 of the damper with the steel pipe can also consume a small part of energy.

The mass of the spherical mass oscillator 1 is determined according to the vibration frequency of the steel pipe structure in the installation position and the spectrum of a load.

The stiffness of the springs 3 is determined according to the vibration frequency of the steel pipe structure in the installation position, the spectrum of the load, and vibration reduction requirements in different directions.

The length of the rigid rods 4 is determined according to the vibration reduction requirements in different directions of the steel pipe structure in the installation position.

The length of the connecting rod 6 is determined according to the attenuation range of the vibration reduction efficiency of a single damper.

When the steel pipe structure installed with the damper vibrates, the spherical mass oscillator 1 connected with the external annular sheet housing 2 through the springs 3 also vibrates, and forms a tuned mass damper with the springs 3 to offset the vibration response of the steel pipe structure caused by part of external excitation. At the same time, the vibration of the spherical mass oscillator 1 causes the collision between the viscoelastic energy absorbing cap 5 on the top of the rigid rods 4 and the annular sheet housing 2. The collision consumes part of vibration energy, and the viscoelastic energy absorbing cap 5 absorbs part of the vibration energy. The spherical mass oscillator 1 is connected with the inner wall of the annular housing of the external annular sheet housing 2 through the springs 3 in multiple directions. The rigid rods 4 are arranged in multiple directions of the spherical mass oscillator 1. Thus, the spherical mass oscillator 1 can vibrate in multiple directions in the plane of the annular housing, and the rigid rods 4 can collide with the annular sheet housing 2.

1. A built-in spatial hammer type impact damper placed in steel tube structures comprising a spherical mass oscillator, an annular housing, springs, rigid rods, a viscoelastic energy absorbing cap and a connecting rod;
the annular sheet housing surrounds the outer side of the spherical mass oscillator; after the annular sheet housing is placed in a circular steel pipe, the annular sheet housing is attached to the inner wall of the steel pipe; in the center surrounded by the annular sheet housing, the spherical mass oscillator is connected with the annular sheet housing through the springs thereon; many rigid rods are fixed to the spherical mass oscillator, these rods are perpendicular to a spherical surface and limited in a plane of the annular sheet housing to ensure a certain distance between the viscoelastic energy absorbing cap on the top of the rigid rods and the annular sheet housing; the distance is adjusted through the length of the rigid rods; the above members form a separate damper; multiple dampers are connected through the connecting rod with a bolt and are placed in the circular steel pipe to form a hammer type impact damper; when the circular steel pipe structure vibrates, a vibration component perpendicular to the circular steel pipe causes the springs to drive the spherical mass oscillator to vibrate; the viscoelastic energy absorbing cap on the top of the rigid rods impacts the annular sheet housing, and the viscoelastic energy absorbing cap absorbs vibration energy; a vibration component parallel to the circular steel pipe is consumed by another damper perpendicular to the component in the circular steel pipe; however, the friction of the annular sheet housing of the damper with the circular steel pipe can also consume a small part of energy.

2. The built-in spatial hammer type impact damper placed in steel tube structures according to claim 1, wherein the mass of the spherical mass oscillator is determined according to the vibration frequency of the steel pipe structure in the installation position and the spectrum of a load.

3. The built-in spatial hammer type impact damper placed in steel tube structures according to claim 1, wherein the stiffness of the springs is determined according to the vibration frequency of the steel pipe structure in the installation position, the spectrum of the load, and vibration reduction requirements in different directions.

4. The built-in spatial hammer type impact damper placed in steel tube structures according to claim 1, wherein the length of the rigid rods is determined according to the vibration reduction requirements in different directions of the steel pipe structure in the installation position.

5. The built-in spatial hammer type impact damper placed in steel tube structures according to claim 3, wherein the length of the rigid rods is determined according to the vibration reduction requirements in different directions of the steel pipe structure in the installation position.

6. The built-in spatial hammer type impact damper placed in steel tube structures according to claim 1, wherein the length of the connecting rod is determined according to the attenuation range of the vibration reduction efficiency of a single damper.

7. The built-in spatial hammer type impact damper placed in steel tube structures according to claim 3, wherein the length of the connecting rod is determined according to the attenuation range of the vibration reduction efficiency of a single damper.

8. The built-in spatial hammer type impact damper placed in steel tube structures according to claim 4, wherein the length of the connecting rod is determined according to the attenuation range of the vibration reduction efficiency of a single damper.

9. The built-in spatial hammer type impact damper placed in steel tube structures according to claim 1, wherein the thickness and the size of the viscoelastic energy absorbing cap are determined according to the size of the impact force of a single damper.

10. The built-in spatial hammer type impact damper placed in steel tube structures according to claim 6, wherein the thickness and the size of the viscoelastic energy absorbing cap are determined according to the size of the impact force of a single damper.
